(19) United States
(12) Patent Application Publication
(10) Pub. No.: US 2026/0098804 A1
(43) Pub. Date: Apr. 9, 2026

(54) Gas Absorption Spectroscopic Instrument

(71) Applicants: SHIMADZU CORPORATION, Kyoto-shi (JP); National University Corporation Tokai National Higher Education and Research System, Nagoya-shi (JP)

(72) Inventors: Kazune MANO, Kyoto-shi (JP); Hideki TOMITA, Nagoya-shi (JP)

(21) Appl. No.: 19/352,150

(22) Filed: Oct. 7, 2025

(30) Foreign Application Priority Data
Oct. 7, 2024 (JP) 2024-175894

(51) Int. Cl. G01N 21/39

(52) U.S. Cl. CPC G01N 21/39; G01N 2021/391

(57) ABSTRACT

The gas absorption spectroscopic instrument includes a light source, a first resonator, a photodetector, a controller, and a first frequency stabilization circuit. The first frequency stabilization circuit includes a second resonator, a frequency adjustment unit, and a lock unit. The frequency adjustment unit generates a laser beam with a main band and a laser beam with a subband. The lock unit locks the laser beam with the subband to the second resonator.

### CROSS REFERENCE TO RELATED APPLICATIONS

This non-provisional application is based on Japanese Patent Application No. 2024-175894 filed on October 7, 2024 with the Japan Patent Office, the entire contents of which are hereby incorporated by reference.

### BACKGROUND OF THE INVENTION

### Field of the Invention

The present disclosure relates to a gas absorption spectroscopic instrument that measures a concentration of a target component in a gas according to cavity ringdown spectroscopy (CRDS).

### Description of the Background Art

Cavity ringdown spectroscopy (CRDS) is known as one kind of gas absorption spectroscopy. CRDS is configured to measure the concentration of a target component contained in a gas in a resonator with high sensitivity by using the resonator (cavity) to increase an effective optical path length.

In the CRDS, a laser beam from a light source is input into a resonator. The laser beam input into the resonator is accumulated in the resonator. After the laser beam is sufficiently accumulated in the resonator, the laser beam is prevented from being input into the resonator. Then, the attenuation of the laser beam escaped from the resonator is measured. The gas absorption spectroscopic instrument acquires an output signal from a photodetector as a "ringdown signal". The gas absorption spectroscopic instrument calculates an attenuation time constant (ringdown time) of the laser beam based on the acquired ringdown signal so as to measure the concentration of a target component contained in the gas in the resonator.

NPL 1 ("Pound-Drever-Hall-locked, frequency-stabilized cavity ringdown spectrometer" by A. Cygan; D. Lisak; P. Maslowski; K. Bielska; S. Wojtewicz; J. Domyslawska; R. S. Trawinski; R. Ciurylo; H. Abe; J. T. Hodges, Review of Scientific Instruments, June 16 2011) discloses a gas absorption spectroscopic instrument in which a feedback system that operates based on the Pound-Drever-Hall (PDH) method is inserted into the optical path from a light source to a resonator. In the NPL 1, the line width of the laser beam is narrowed by locking the laser beam to the resonator in accordance with the PDH method.

### SUMMARY OF THE INVENTION

In general, a resonator with a high finesse is used in the CRDS. Therefore, in the gas absorption spectroscopic instrument described in the NPL 1, it is very difficult to lock the laser beam to the resonator, and thereby it is difficult to stabilize the frequency of the laser beam and narrow the line width thereof.

An object of the present disclosure is to stabilize a frequency of a laser beam and narrow a line width thereof without locking the laser beam to a resonator used for CRDS measurement.

A gas absorption spectroscopic instrument according to the present disclosure is a gas absorption spectroscopic instrument that measures a gas component, and the gas absorption spectroscopic instrument includes: a light source that outputs a laser beam for measuring the gas component; a first resonator into which the laser beam is input; a photodetector that detects a laser beam output from the first resonator; a controller that measures the gas component based on an output signal from the photodetector; and a first frequency stabilization circuit disposed between the light source and the first resonator to form a negative feedback circuit. The first frequency stabilization circuit includes: a second resonator having a finesse lower than that of the first resonator; a frequency adjustment unit that adjusts a frequency of the laser beam; and a lock unit that locks the laser beam to the second resonator. The frequency adjustment unit generates a laser beam with a main band for measuring the gas component and a laser beam with a subband from the laser beam. The lock unit locks the laser beam with the subband to the second resonator.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram schematically illustrating a gas absorption spectroscopic instrument.

FIG. 2 is a conceptual diagram illustrating a mode frequency.

FIG. 3 is a diagram schematically illustrating a detailed configuration of a frequency stabilization circuit.

FIG. 4 is a diagram illustrating an example of an oscillation frequency of a measurement Quantum Cascade Laser (QCL) obtained by modulating the measurement QCL with two kinds of frequencies.

FIG. 5 is a block diagram illustrating a frequency adjustment unit and a lock unit provided in the frequency stabilization circuit.

FIG. 6 is a diagram schematically illustrating a gas absorption spectroscopic instrument according to a modification.

FIG. 7 is a diagram schematically illustrating a gas absorption spectroscopic instrument according to a comparative example.

### DESCRIPTION OF THE PREFERRED EMBODIMENTS

Hereinafter, an embodiment will be described in detail with reference to the drawings. In the following description, the same or corresponding parts in the drawings will be denoted by the same reference numerals, and the description thereof will not be repeated.

### Configuration of Gas Absorption Spectroscopic Instrument

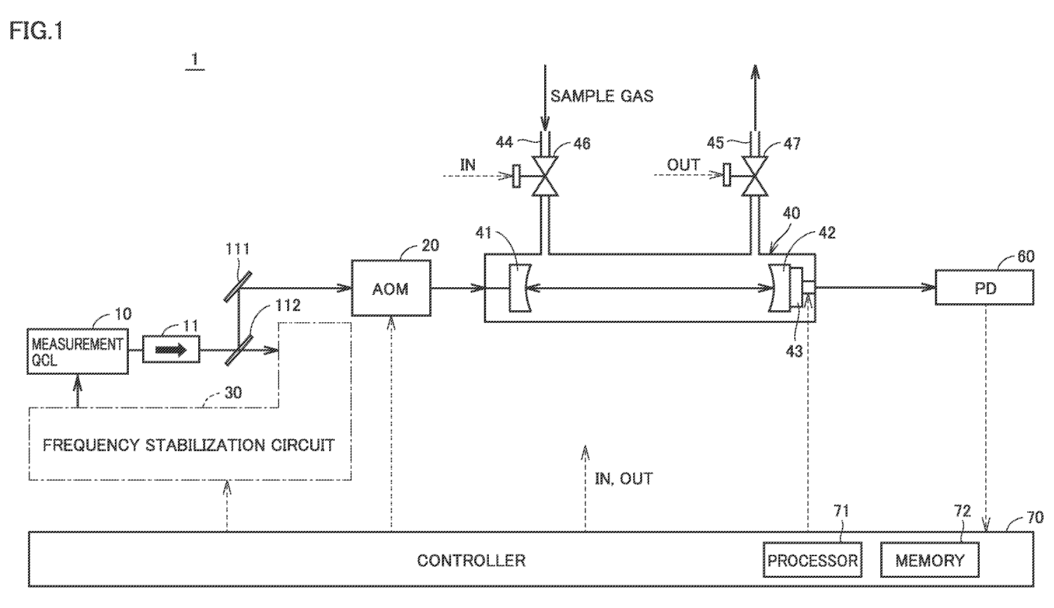

FIG. 1 is a diagram schematically illustrating a gas absorption spectroscopic instrument 1 according to the present embodiment. The gas absorption spectroscopic instrument 1 includes a measurement quantum cascade laser (QCL) 10, an isolator 11, an acousto-optical modulator (AOM) 20, a frequency stabilization circuit 30, a CRDS resonator 40, a photodetector (PD) 60, and a controller 70.

The measurement QCL 10 is an example of a light source that outputs a laser beam for measuring a gas component. The measurement QCL 10 is configured to modify an oscillation frequency of the laser beam in accordance with a command from the controller 70. Specifically, the measurement QCL 10 is a distributed feedback quantum cascade laser (QCL).

The AOM 20 and the frequency stabilization circuit 30 are disposed in an optical path between the measurement QCL 10 and the CRDS resonator 40. The AOM 20 is an example of an optical modulator. The AOM 20 is an optical switch (switching unit) that rapidly switches to output or block a laser beam from the measurement QCL 10 to the CRDS resonator 40. When an ON command for outputting a laser beam is applied from the controller 70, the AOM 20 is turned on so that a laser beam is output from the measurement QCL 10 to the CRDS resonator 40. When an OFF command for blocking a laser beam is applied from the controller 70, the AOM 20 is turned off so that a laser beam is not output from the measurement QCL 10 to the CRDS resonator 40.

The CRDS resonator 40 is disposed in the optical path between the AOM 20 and the photodetector 60. The CRDS resonator 40 is an example of a first resonator. The CRDS resonator 40 includes a sealed container (cell) for storing a sample gas, an introduction pipe 44 for introducing the sample gas into the CRDS resonator 40 before the measurement, and a discharge pipe 45 for discharging the sample gas to the outside of the CRDS resonator 40 after the measurement. The introduction pipe 44 is provided with an introduction valve 46. The discharge pipe 45 is provided with a discharge valve 47. The controller 70 controls the opening and closing of the inlet valve 46 and the outlet valve 47.

A pair of mirrors 41 and 42 are disposed inside the CRDS resonator 40. The pair of mirrors 41 and 42 are disposed to face each other so as to reflect light therebetween inside the CRDS resonator 40. In order to easily satisfy the stability conditions of the CRDS resonator 40, at least one of the mirrors 41 and 42 is a concave mirror. The mirrors 41 and 42 have a high reflectivity (for example, about 99.9%) so as to minimize the leakage of light to the outside of the CRDS resonator 40. The number of mirrors disposed inside the CRDS resonator 40 is not limited to two, and may be three or more. In other words, the mirrors in the resonator may be arranged to reflect light therebetween, or the mirrors in the resonator may be arranged in a ring shape so as to reflect light in one direction.

A piezoelectric element (piezo element) 43 is disposed on the mirror 42. The piezoelectric element 43 drives the mirror 42 included in the CRDS resonator 40 in accordance with a command from the controller 70 so as to shift the mirror 42 in the optical axis direction. This adjusts a resonator length of the CRDS resonator 40. The piezoelectric element may be disposed on the mirror 41 instead of the mirror 42, or the piezoelectric element may be disposed on both the mirror 41 and the mirror 42.

The photodetector 60 is, for example, a photodiode. The photodetector 60 detects weak light reflected by the mirror 42 of the CRDS resonator 40 as an output light of the CRDS resonator 40, and outputs a detection signal to the controller 70. The photodetector 60 is an example of a photodetector that detects a laser beam output from the first resonator. As the photodetector 60, for example, a liquid-nitrogen-cooled InSb (indium antimonide) detector may be used.

A beam splitter 112 and a mirror 111 are disposed in the optical path between the measurement QCL 10 and the AOM 20. The beam splitter 112 is configured to split the laser beam output from the measurement QCL 10 into a laser beam travelling through an optical path to the AOM 20 and a laser beam travelling through an optical path to the frequency stabilization circuit 30. The mirror 111 is configured to reflect one of the two laser beam split by the beam splitter 112 to the AOM 20.

The isolator 11 is disposed in the optical path between the measurement QCL 10 and the beam splitter 112. The isolator 11 restricts the travelling direction of the laser beam from the measurement QCL 10 toward the beam splitter 112. By disposing the isolator 11 near the measurement QCL 10, it is possible to prevent the frequency of the laser beam from becoming unstable due to return light.

The controller 70 includes a processor 71 such as a CPU (Central Processing Unit) or FPGA (Field-Programmable Gate Array), a memory 72 such as a ROM (Read Only Memory) or a RAM (Random Access Memory), and an input/output port (not shown).

The controller 70 controls each unit constituting the gas absorption spectroscopic instrument 1. Specifically, the controller 70 outputs a command for scanning the oscillation frequency of the laser beam or outputs an ON signal or an OFF signal to the AOM 20. The controller 70 outputs, to the introduction valve 46, an introduction command for introducing the sample gas into the CRDS resonator 40, and outputs to, the discharge valve 47, a discharge command for discharging the sample gas to the outside of the CRDS resonator 40.

The controller 70 applies a voltage to the piezoelectric element 43 to shift the mirror 42 so as to adjust the resonator length of the CRDS resonator 40. The controller 70 executes various data processes. The various data processes include a process of calculating the concentration (absolute concentration) of a target component contained in the sample gas based on a detection signal from the photodetector 60.

The controller 70 may be divided into two or more units based on the functions thereof. For example, the controller 70 may be divided into a unit that controls each device and a unit that executes various data processes.

### Principle of Measurement by Cavity Ringdown Spectroscopy (CRDS)

The principle of measurement by cavity ringdown absorption spectroscopy in the gas absorption spectroscopic instrument 1 will be described. In general, resonance occurs in a resonator when the frequency of light irradiated into the resonator is a specific frequency. Hereinafter, the frequency of a laser beam input into the CRDS resonator 40 is referred to as a "laser frequency", and the frequency of a laser beam that can cause resonance in the CRDS resonator 40 is referred to as a "mode frequency".

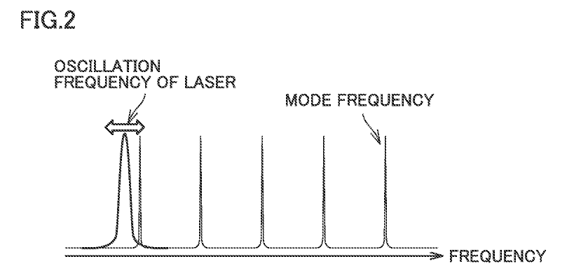

FIG. 2 is a conceptual diagram illustrating a mode frequency. As illustrated in FIG. 2, a plurality of mode frequencies exist at predetermined frequency intervals. Hereinafter, an interval between two adjacent mode frequencies among the plurality of mode frequencies is referred to as a "free spectral range" (FSR).

If the laser frequency does not match any of the mode frequencies, the power of the laser beam is not accumulated in the CRDS resonator 40. On the other hand, if the laser frequency matches any of the mode frequencies, the power of the laser beam is accumulated in the CRDS resonator 40. The controller 70 adjusts the resonator length of the CRDS resonator 40 so that the laser frequency matches the mode frequency.

The controller 70 determines whether or not the power of the laser beam is sufficiently accumulated in the CRDS resonator 40 based on the output signal from the photodetector 60. If it is determined that the power of the laser beam is sufficiently accumulated in the CRDS resonator 40, the controller 70 outputs an OFF signal to the AOM 20. Thus, the laser beam to be input to the CRDS resonator 40 is blocked.

Then, the laser beam in the CRDS resonator 40 reciprocates between the mirror 41 and the mirror 42 for a plurality of times (typically several thousands to several tens of thousands of times). As the laser beam reciprocates between the mirrors 41 and 42, the laser beam gradually attenuates due to the loss caused by the leakage in transmission of the mirrors 41 and 42 and the absorption caused by the target component in the sample gas. Therefore, the laser beam output from the CRDS resonator 40, i.e., leaked from the mirror 42 gradually attenuates. Since the distance for the laser beam to travel through the sample gas (effective optical path length) is increased by using the CRDS resonator 40, even if the light adsorption by the target component is an extremely small amount, the light adsorption can be detected by the CRDS.

When the laser beam to be input to the CRDS resonator 40 is blocked, the controller 70 acquires a signal from the photodetector 60 as a "ringdown signal". The controller 70 calculates an attenuation time constant of the acquired ringdown signal as a "ringdown time". The controller 70 calculates the concentration of the target component contained in the sample gas based on the calculated ringdown time.

### Configuration of Frequency Stabilization Circuit

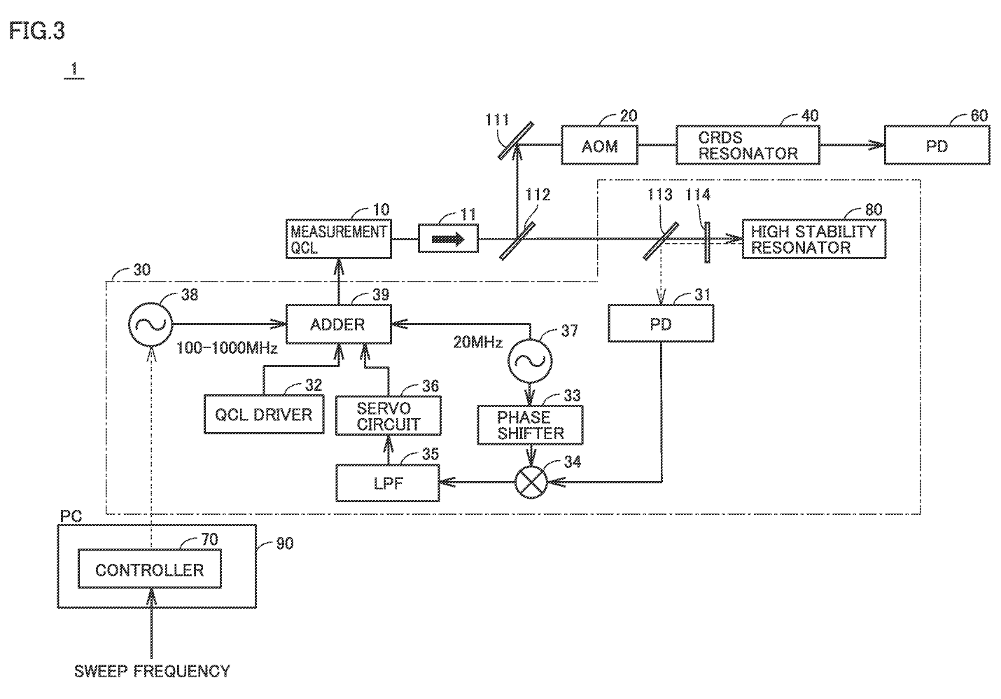

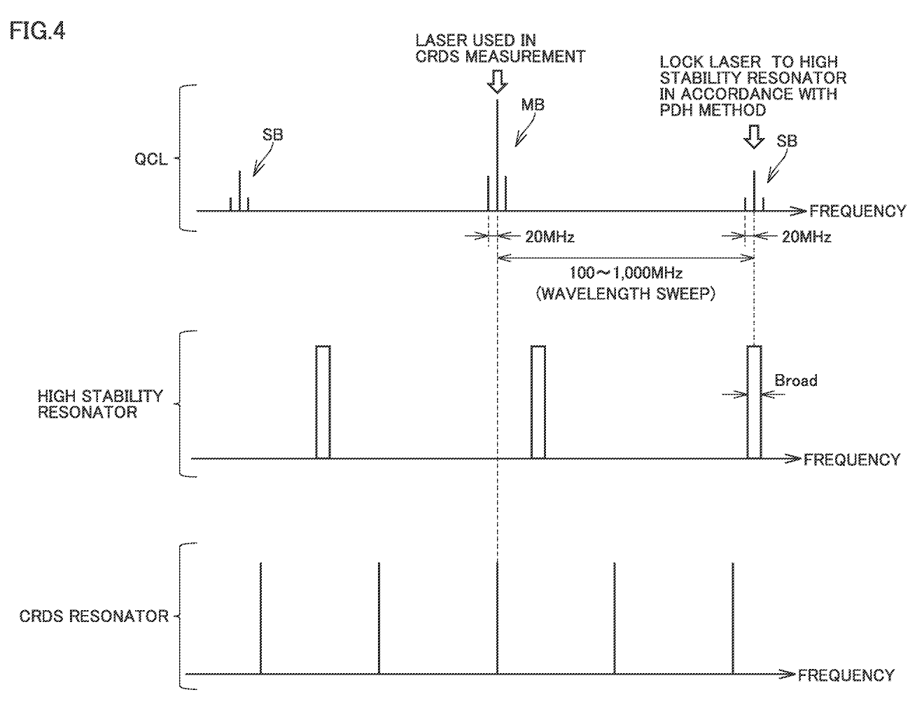

FIG. 3 is a diagram schematically illustrating a detailed configuration of the frequency stabilization circuit 30. FIG. 4 is a diagram illustrating an example of an oscillation frequency of a measurement QCL obtained by modulating the measurement QCL with two kinds of frequencies. FIG. 4 also illustrates a frequency spectrum resonating in the high stability resonator 80 and a frequency spectrum resonating in the CRDS resonator 40.

As illustrated in FIG. 3, the frequency stabilization circuit 30 is disposed between the measurement QCL 10 and the CRDS resonator 40 to form a negative feedback circuit. The frequency stabilization circuit 30 includes a photodetector 31, a QCL driver 32, a phase shifter 33, a phase comparator 34, a low pass filter (LPF) 35, a servo circuit 36, a radio frequency (RF) generator 37, a radio frequency (RF) generator 38, an adder 39, a high stability resonator 80, a polarization beam splitter 113, and a 1/4 wave plate 114.

The laser beam output from the QCL for measurement 10 is split by the beam splitter 112 into a laser beam to the CRDS resonator 40 and a laser beam to the frequency stabilization circuit 30. The laser beam entering the frequency stabilization circuit 30 travels toward the polarization beam splitter 113.

The polarization beam splitter 113 allows a part of the laser beam to travel toward the high stability resonator 80. The 1/4 wave plate 114 changes the polarization state of the laser beam incident from the polarization beam splitter 113 and causes the laser beam to enter the high stability resonator 80. Thereafter, the 1/4 wave plate 114 changes the polarization state of the laser beam returned from the high stability resonator 80 and returns the laser beam to the polarization beam splitter 113. The polarization beam splitter 113 reflects the laser beam returned from the high stability resonator 80 via the 1/4 wave plate 114 at an angle of approximately 90 degrees. The photodetector 31 detects the laser beam reflected by the polarization beam splitter 113. The photodetector 31 outputs an electrical signal corresponding to the intensity of the laser beam to the phase comparator 34.

Each of the RF generators 37 and 38 functions as a generation unit that generates a modulation signal. The RF generator 37 generates a modulation signal having a reference frequency. The reference frequency is 20 MHz, for example. When the laser beam is modulated at the reference frequency, as illustrated in FIG. 4, a frequency spectrum centered at a peak value and having an amplitude of 20 MHz appears in a main band MB. The peak value of the main band MB is used for CRDS measurement. As illustrated in FIG. 4, the controller 70 is configured to match the peak value of the main band MB with the resonance frequency of the CRDS resonator. The RF generator 37 is an example of a first generator.

The RF generator 38 generates a modulation signal having a "sweep frequency". The "sweep frequency" indicates a sweep amount of the main band MB. The RF generator 38 generates a modulation signal having a sweep frequency within a predetermined sweep range in accordance with a command from the controller 70. The predetermined sweep range is 100 to 1000 MHz, for example. When the laser beam is modulated at the sweep frequency in addition to the reference frequency, as illustrated in FIG. 4, a frequency spectrum centered at a peak value and having an amplitude of 20 MHz appears in a subband SB located on both the left side and the right side of the main band MB. The frequency difference between the peak value of the subband SB and the peak value of the main band MB is equal to the sweep frequency. The RF generator 38 is an example of a second generator.

The RF generator 37 outputs the modulation signal to the phase shifter 33 and the adder 39. The RF generator 38 outputs the modulation signal to the adder 39 according to a command from the controller 70.

The phase shifter 33 shifts the phase of the modulation signal output from the RF generator 37 by 180 degrees. The phase comparator 34 calculates a comparison value (difference) between the detection signal detected by the photodetector 31 and the modulation signal output from the RF generator 37. The phase comparator 34 outputs the comparison value between the detection signal and the modulation signal output from the RF generator 37 to the low pass filter 35. The comparison value output to the low pass filter 35 corresponds to an error between the resonance frequency of the high stability resonator 80 and the frequency of the laser beam. The low pass filter 21 generates an error signal (beat signal) based on the error.

The QCL driver 32 outputs a DC modulation signal to the adder 39. The servo circuit 22 outputs, to the adder 39, a signal for adjusting the frequency of the laser beam to the resonance frequency of the high stability resonator 16.

The adder 39 adjusts the frequency of the laser beam output from the measurement QCL 10 based on the signal received from the servo circuit 36. Further, the adder 39 modulates the frequency of the laser beam output from the measurement QCL 10 based on the modulation signal received from the RF generator 37 and the modulation signal received from the RF generator 38. The measurement QCL 10 outputs a laser beam modulated according to the signal output from the adder 39. As a result, as described with reference to FIG. 4, the main band MB and the sub-band SB appear in the frequency spectrum of the laser beam.

The process described above is repeated between the measurement QCL 10 and the frequency stabilization circuit 30. As a result, the above-described error becomes smaller gradually.

Thus, the frequency stabilization circuit 30 outputs the laser beam after frequency modulation to the high stability resonator 80, detects the laser beam output from the high stability resonator 80 by using the photodetector 31, and applies a feedback based on the detected laser beam, thereby stabilizing the frequency of the laser beam.

In other words, the frequency stabilization circuit 30 operates in accordance with the PDH (Pound-Drever-Hall) method, and locks the laser beam from the measurement QCL 10 to the high stability resonator 80. In other words, the frequency stabilization circuit 30 performs a PDH control.

The high stability resonator 80 is not provided with a mechanism for adjusting the resonator length. In other words, in the high stability resonator 80, the resonator length is fixed. Similar to the CRDS resonator 40, a pair of mirrors (not shown) is disposed inside the high stability resonator 80. However, the reflectivity of the pair of mirrors disposed in the high stability resonator 80 is lower than the reflectivity of the pair of mirrors disposed in the CRDS resonator 40. Thus, the finesse of the high stability resonator 80 is lower than the finesse of the CRDS resonator 40.

Generally, the finesse becomes higher as the spectrum of the resonance frequency becomes steeper or as the free spectral range (FSR) becomes wider. In order to improve the accuracy of the CRDS measurement, it is necessary to extremely narrow the resonance line width of the CRDS resonator 40. Therefore, the CRDS resonator 40 having a high finesse is used in the gas absorption spectroscopic instrument 1.

In the present embodiment, the coupling between the main band MB and the CRDS resonator 40 is enhanced by narrowing the line width of the main band MB, and the peak value of the main band MB having a narrow line width is used in the measurement. Thus, it is considered that the laser beam with the main band MB output from the measurement QCL 10 is directly locked to the CRDS resonator 40. However, it is extremely difficult to directly lock the laser beam output from the measurement QCL 10 to the CRDS resonator 40 having a high finesse. The reason is that the wavelength stability of the laser beam is insufficient if the resonance line width is extremely narrowed.

Therefore, in the present embodiment, instead of locking the laser beam to the CRDS resonator 40, it is proposed to lock the laser beam to the high stability resonator 80 having a low finesse (i.e., a broad resonance line width). A mirror having a moderately reduced reflectivity is used in the high stability resonator 80 so as to obtain a sufficient finesse for stable locking. In particular, in the present embodiment, in order to prevent the resonator length from varying, a resonator having a fixed resonator length is employed as the high stability resonator 80. Accordingly, the laser beam can be more stably locked by the high stability resonator 80. The high stability resonator 80 is an example of a second resonator having a finesse lower than that of the first resonator.

Further, in the present embodiment, the laser beam to be locked to the high stability resonator 80 is not the laser beam with the main band MB but the laser beam with the subband SB. The reason is that if the oscillation peak of a laser beam with the main band MB is locked to the resonance frequency of the high stability resonator 80 having a fixed resonator length, the wavelength sweep cannot be performed.

By locking the laser beam with the subband SB to the high stability resonator 80, the laser beam with the subband SB resonates in the high stability resonator 80. Since the finesse of the high stability resonator 80 is low, the laser beam can be locked to the high stability resonator 80 with a relatively broad narrow line width (see FIG. 4). In other words, by using the high stability resonator 80, the laser beam can be easily locked with a relatively loose requirement.

In the present embodiment, the subband SB of the laser beam is controlled so that the subband SB matches the resonance frequency of the high stability resonator 80. In other words, the frequency stabilization circuit 30 locks the laser beam with the subband SB to the high stability resonator 80. For example, if the sweep frequency is 100 MHz, the measurement QCL 10 oscillates when the laser beam with the subband SB is locked to the high stability resonator 80 and the frequency difference between the peak of the main band MB and the peak of the subband SB is 100 MHz.

The laser beam with the main band MB and the laser beam with the subband SB are generated by a common light source. Therefore, if the laser beam with the subband SB is locked to the high stability resonator 80 and the frequency thereof is stabilized, the frequency of the laser beam with the main band MB can also be stabilized in the CRDS resonator 40.

In order to stabilize the frequency of the laser beam with the main band MB in the CRDS resonator 40, after locking the laser beam with the subband SB to the high stability resonator 80, the controller 70 shifts the resonant frequency of the CRDS resonator 40 by an amount corresponding to the sweep frequency. More specifically, the controller 70 adjusts the resonator length of the CRDS resonator 40 so that the peak value of the main band MB matches the resonance frequency of the CRDS resonator 40. As a result, the frequency of the laser beam with the main band MB resonating in the CRDS resonator 40 is moved toward the sweeping direction. As a result, the frequency of the laser beam with the main band MB is also stabilized and the line width thereof is also narrowed in the CRDS resonator 40. Thereafter, the controller 70 proceeds to the measurement process.

As illustrated in FIG. 3, the controller 70 may be included in a personal computer (PC) 90. The personal computer 90 may include, for example, an operation reception unit such as a keyboard and a mouse, an information input interface, and a display. The personal computer 90 may receive a sweep frequency via the operation reception unit or the information input interface. In this case, the controller 70 may output, to the RF generator 38, a command signal for generating the received sweep frequency.

By adjusting the sweep frequency while locking the laser beam with the subband SB to the high stability resonator 80, the controller 70 can control the frequency difference between the laser beam with the subband SB and the laser beam with the main band MB for CRDS measurement. Therefore, the controller 70 can freely sweep the main band MB after the line width of the laser beam with the main band MB is narrowed, and acquire the ringdown signal at a required frequency difference. As a result, the controller 70 can measure the spectrum in the same manner as in the related art.

According to the present embodiment, it is possible to stabilize the frequency and narrow the line width of a laser beam with the main band MB used for measurement without locking the laser beam to the CRDS resonator 40. In the present embodiment, the error signal for PDH control is acquired by performing a current modulation on the signal output from the QCL driver 32, but a phase modulation may be performed instead of the current modulation. In this case, an electro-optical modulator (EOM) may be used.

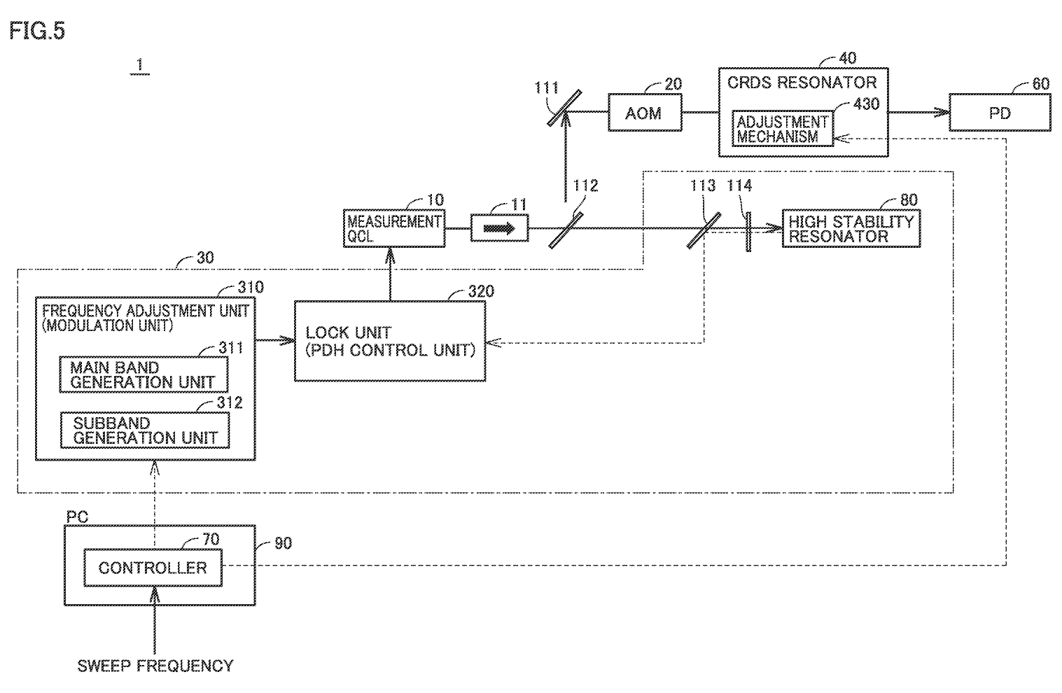

FIG. 5 is a block diagram illustrating a frequency adjustment unit 310 and a lock unit 320 included in the frequency stabilization circuit 30. The frequency stabilization circuit 30 described with reference to FIG. 3 functionally includes a frequency adjustment unit (modulation unit) 310 and a lock unit (PDH control unit) 320. The frequency adjustment unit 310 and the lock unit 320 are realized by combining necessary functions of the photodetector 31, the QCL driver 32, the phase shifter 33, the phase comparator 34, the low pass filter 35, the servo circuit 36, the RF generators 37 and 38, and the adder 39.

The frequency adjustment unit 310 generates a laser beam that has the main band MB for measuring the gas component and the subband SB from the laser beam. More specifically, the frequency adjustment unit 310 generates a laser beam with the main band MB and a laser beam with the subband SB by modulating the laser beam. The frequency adjustment unit 310 includes a main band generation unit 311 that generates a laser beam with the main band MB and a subband generation unit 312 that generates a laser beam with the subband SB. The lock unit 320 locks the laser beam with the subband SB to the high stability resonator 80.

The frequency adjustment unit 310 includes an RF generator 37 that outputs a modulation signal for generating a laser beam with the main band MB and an RF generator 38 that outputs a modulation signal for generating a laser beam with the subband SB. The controller 70 adjusts the oscillation frequency of the RF generator 38 to modify the frequency difference between the laser beam with the main band MB and the laser beam with the subband SB. In other words, the controller 70 performs wavelength sweep by adjusting the oscillation frequency of the RF generator 38.

The CRDS resonator 40 includes an adjustment mechanism 430 for adjusting the resonator length. The adjustment mechanism 430 includes the piezoelectric element 43 illustrated in FIG. 1. The controller 70 adjusts the resonator length of the CRDS resonator 40 using the adjustment mechanism 430 such that the CRDS resonator 40 resonates in the main band MB while the laser beam with the subband SB is being locked to the high stability resonator 80. Thus, the CRDS measurement can be performed.

### Modification

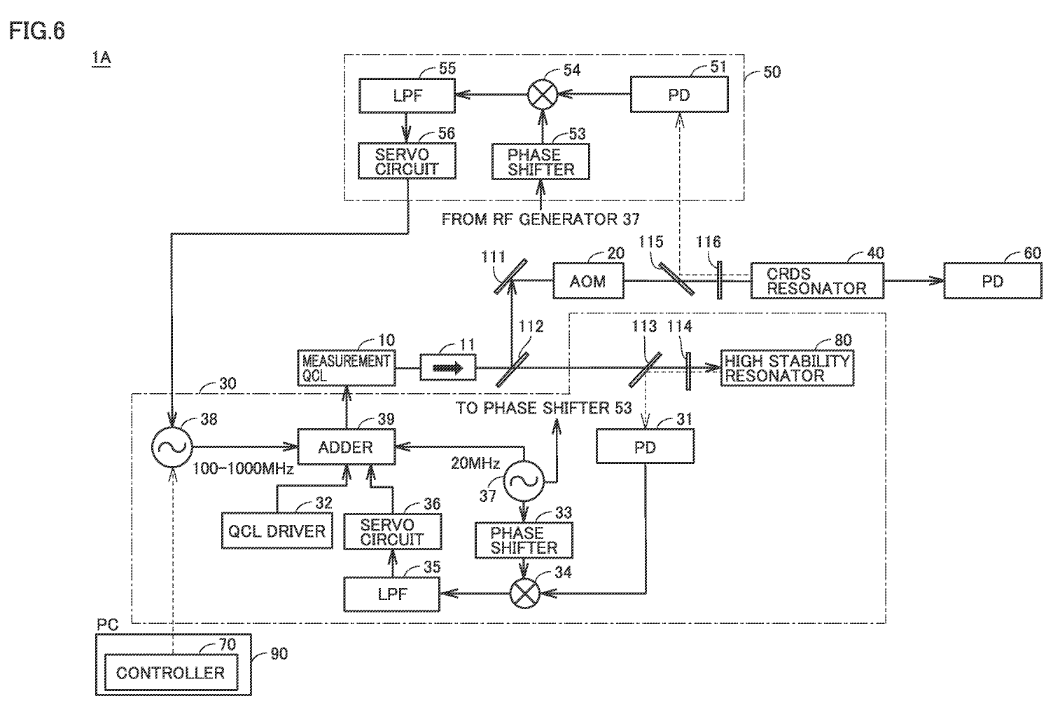

FIG. 6 is a diagram schematically illustrating a gas absorption spectroscopic instrument 1A according to a modification. The gas absorption spectroscopic instrument 1A is different from the gas absorption spectroscopic instrument 1 in that it includes a frequency stabilization circuit 50, a polarization beam splitter 115, and a 1/4 wavelength plate 116. The configuration of the gas absorption spectroscopic instrument 1A is the same as the configuration of the gas absorption spectroscopic instrument 1 except for the frequency stabilization circuit 50, the polarization beam splitter 115, and the 1/4 wave plate 116. The polarization beam splitter 115 and the 1/4 wave plate 116 may be replaced with an isolator provided with a return light output port. Thus, instead of circularly polarized light, linearly polarized light can be incident on the resonator.

The frequency stabilization circuit 50 includes a photodetector 51, a phase shifter 53, a phase comparator 54, a low pass filter 55, and a servo circuit 56. A modulation signal from the RF generator 37 is input to the phase shifter 53. The servo circuit 56 controls the oscillation frequency of the RF generator 38.

The laser beam incident on the AOM 20 from the measurement QCL 10 travels to the polarization beam splitter 115. The polarization beam splitter 115 allows a part of the laser beam to travel to the CRDS resonator 40. The 1/4 wave plate 116 changes the polarization state of the laser beam incident from the polarization beam splitter 115 and causes the laser beam to enter the CRDS resonator 40. The 1/4 wave plate 114 changes the polarization state of the laser beam returned from the CRDS resonator 40 and returns the laser beam to the polarization beam splitter 115. The polarization beam splitter 115 outputs the laser beam returned from the CRDS resonator 40 via the 1/4 wave plate 116 to the frequency stabilization circuit 50. The laser beam input to the frequency stabilization circuit 50 is detected by the photodetector 51.

The frequency stabilization circuit 50 operates in accordance with the PDH method in the same manner as the frequency stabilization circuit 30, and performs the PDH control. Similar to the photodetector 31, the phase shifter 33, the phase comparator 34, the low pass filter 35 and the servo circuit 36, the photodetector 51, the phase shifter 53, the phase comparator 54, the low pass filter 55 and the servo circuit 56 are configured to perform the PDH control.

The phase comparator 54 outputs, to the low pass filter 55, a comparison value between the detection signal detected by the photodetector 51 and the modulation signal output from the RF generator 37. The comparison value output to the low pass filter 55 corresponds to an error between the resonance frequency of the CRDS resonator 40 and the main band MB of the laser beam. The low pass filter 55 generates an error signal based on the error. The servo circuit 56 controls the oscillation frequency of the RF generator 38 so as to adjust the main band MB to the resonance frequency of the CRDS resonator 40.

Thus, the frequency stabilization circuit 50 locks the laser beam with the main band MB to the CRDS resonator 40. In the frequency stabilization circuit 30, since the laser beam with the subband SB is locked to the high stability resonator 80, the laser beam having a narrow resonance line width in the main band MB can be easily locked to the CRDS resonator 40. The servo circuit 56 sweeps the wavelength of the laser beam output from the measurement QCL 10 by varying the oscillation frequency of the RF generator 38. The servo circuit 56 matches the resonance frequency of the CRDS resonator 40 with the frequency of the laser beam output from the measurement QCL 10 by inputting an error signal to the RF generator 38.

The gas absorption spectroscopic instrument 1 illustrated in FIG. 3 is not provided with a lock unit for locking the laser beam with the main band MB to the CRDS resonator 40. Therefore, if there is a slight deviation in the resonance frequency between the CRDS resonator 40 and the laser beam output from the measurement QCL 10, the ringdown signal cannot be acquired. In this case, the user is required to finely adjust the sweep frequency of the RF generator 38 so that the resonance condition is satisfied.

However, in the gas absorption spectroscopic instrument 1A, such adjustment is not necessary. Therefore, in the gas absorption spectroscopic instrument 1A, the ringdown signal can be constantly acquired without considering the deviation in the resonance frequency between the CRDS resonator 40 and the laser beam output from the measurement QCL 10. According to the gas absorption spectroscopic instrument 1A, it is possible to perform the wavelength sweep while constantly resonating the laser beam output from the CRDS resonator 40 and the measurement QCL 10. Thus, according to the gas absorption spectroscopic instrument 1A, it is possible to maintain a narrow resonance line width in the CRDS resonator 40.

Further, since the laser beam output from the measurement QCL 10 and the CRDS resonator 40 are constantly kept in resonance, the speed of measuring the ringdown signal can be increased. Accordingly, the user can perform the CRDS measurement more stably. The frequency stabilization circuit 50 is an example of a second frequency stabilization circuit that locks the laser beam with the main band to the first resonator.

The servo circuit 56 may be configured to output the control signal to the controller 70 without outputting the control signal to the RF generator 38. In this case, the controller 70 adjusts the oscillation frequency of the RF generator 38 based on the control signal from the servo circuit 56. Further, the frequency stabilization circuit 50 controls the modulation frequency of the RF generator 38 so as to realize the PDH control. However, the frequency stabilization circuit 50 may control the frequency and the phase using an AOM (Acousto-Optic Modulator) or an EOM (Electro-Optic Modulator) so as to perform the PDH control.

The frequency stabilization circuit 50 controls the frequency of the generator 38. The gas absorption spectroscopic instrument 1A comprises an AOM 20 disposed between the measurement QCL 10 and the CRDS resonator 40. The frequency stabilization circuit 50 may control the frequency of the AOM 20. The frequency stabilization circuit 50 may control the resonator length of the CRDS resonator 40.

### Comparative Example

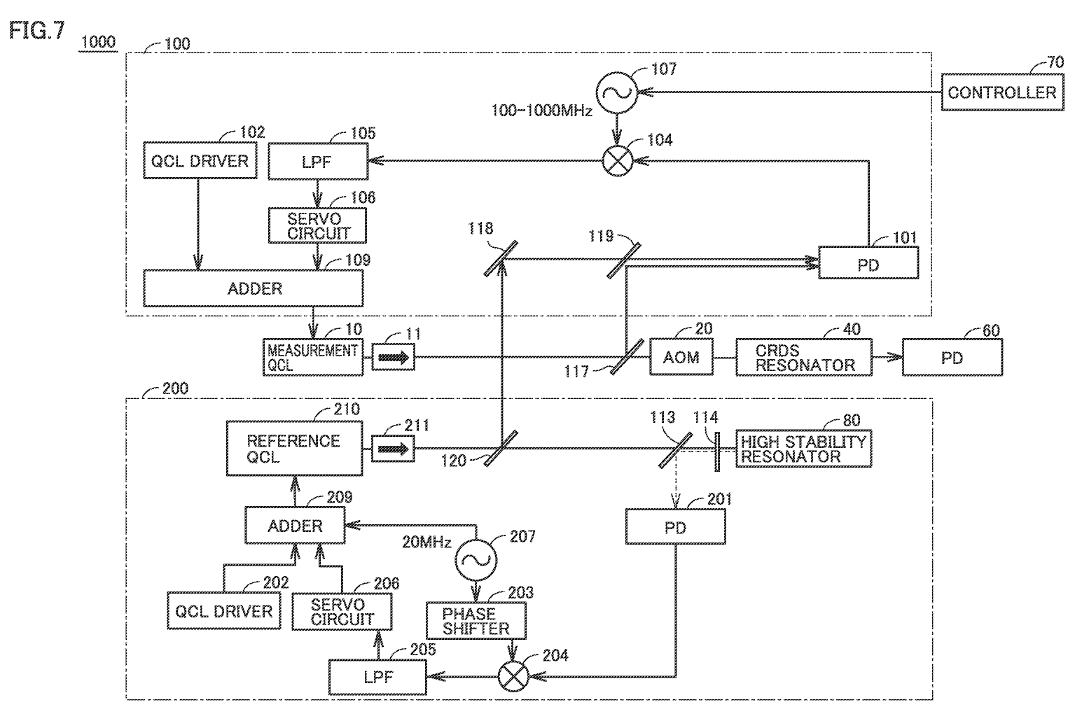

FIG. 7 is a diagram schematically illustrating a gas absorption spectroscopic instrument 1000 according to a comparative example. The gas absorption spectroscopic instrument 1000 includes a measurement QCL 10, an isolator 11, an AOM 20, a CRDS resonator 40, a photodetector 60, a controller 70, a frequency stabilization circuit 100, and a frequency stabilization circuit 200.

Similar to the gas absorption spectroscopic instrument 1, in the gas absorption spectroscopic instrument 1000 according to the comparative example, it is possible to stabilize the frequency of the laser beam and narrow the line width thereof without locking the laser beam to the CRDS resonator 40. However, as to be described hereinafter, the gas absorption spectroscopic instrument 1000 requires more components than the gas absorption spectroscopic instrument 1.

The frequency stabilization circuit 100 includes a photodetector 101, a QCL driver 102, a phase comparator 104, a low pass filter 105, a servo circuit 106, an RF generator 107, an adder 109, a mirror 118, and a beam splitter 119. Similar to the RF generator 38, the RF generator 107 generates a modulation signal in the range of 100 to 1000 MHz in response to a command from the controller 70.

The frequency stabilization circuit 200 includes a photodetector 101, a QCL driver 102, a phase comparator 104, a high stability resonator 80, a polarization beam splitter 113, a 1/4 wave plate 114, a beam splitter 120, a phase shifter 203, a low pass filter 205, a servo circuit 206, an RF generator 207, an adder 209, a reference QCL 210, and an isolator 211.

The frequency stabilization circuit 200 locks the laser beam output from the reference QCL 210 to the high stability resonator 80. The phase comparator 104, the phase shifter 203, the low pass filter 205, the servo circuit 206, the RF generator 207, the adder 209, and the like included in the frequency stabilization circuit 200 function as a PDH circuit for locking the laser beam output from the reference QCL 210 to the high stability resonator 80 in accordance with the PDH control.

The laser beam which is output from the reference QCL 210 and is highly stabilized and the laser beam which is output from the measurement QCL 10 are output to the frequency stabilization circuit 100. In the frequency stabilization circuit 100, the laser beam output from the reference QCL 210 and the laser beam output from the measurement QCL 10 are detected by the photodetector 101. The photodetector 31 outputs, to the phase comparator 104, an electrical signal corresponding to the intensity of the laser beam. The RF generator 107 outputs the sweep frequency to the phase comparator 104.

The phase comparator 104 calculates a comparison value (difference) between the laser beam output from the reference QCL 210 and the laser beam output from the measurement QCL 10. The comparison value corresponds to an error between the frequency of the laser beam from the reference QCL 210 which is highly stabilized and the frequency of the laser beam from the measurement QCL 10. Then, the phase comparator 104 outputs a difference between the error and the sweep frequency to the low pass filter 105. The low pass filter 105 generates an error signal based on the difference.

The QCL driver 102 outputs a DC modulation signal to the adder 109. The servo circuit 106 outputs, to the adder 109, a signal for adjusting the frequency of the laser beam based on the error signal.

The adder 109 adjusts the frequency of the laser beam output from the measurement QCL 10 using the signal received from the servo circuit 106. As a result, similar to the measurement QCL 10 of the gas absorption spectroscopic instrument 1, the measurement QCL 10 of the gas absorption spectroscopic instrument 1000 outputs a laser beam modulated according to the reference frequency and the sweep frequency. This laser beam is based on the laser beam of the reference QCL 210 which is highly stabilized and narrowed in the frequency stabilization circuit 200. Therefore, the laser beam output from the measurement QCL 10 is also highly stabilized and has a narrow line width. Therefore, similar to the gas absorption spectroscopic instrument 1, the gas absorption spectroscopic instrument 1000 according to the comparative example can stabilize the frequency of the laser beam and narrow the line width thereof in the main band for the measurement without locking the laser beam to the CRDS resonator 40.

However, according to the comparative example, a large number of components are required in addition to the reference QCL 210, which makes the configuration complicated. On the other hand, according to the gas absorption spectroscopic instrument 1, it is possible to stabilize the frequency of the laser beam and narrow the line width thereof in the main band used for the measurement without locking the laser beam to the CRDS resonator 40 with a simple configuration. In particular, according to the gas absorption spectroscopic instrument 1, as compared with the comparative example, only one laser beam source is required for wavelength stabilization, and thereby, the optical element and the control system can be simplified.

### Aspects

It will be understood by those skilled in the art that the embodiments described above are specific examples of the following aspects.

(First Aspect) A gas absorption spectroscopic instrument according to the present disclosure is configured to measure a gas component, and includes: a light source that outputs a laser beam for measuring the gas component; a first resonator into which the laser beam is input; a photodetector that detects a laser beam output from the first resonator; a controller that measures the gas component based on an output signal from the photodetector; and a first frequency stabilization circuit disposed between the light source and the first resonator to form a negative feedback circuit. The first frequency stabilization circuit includes: a second resonator having a finesse lower than that of the first resonator; a frequency adjustment unit that adjusts a frequency of the laser beam; and a lock unit that locks the laser beam to the second resonator. The frequency adjustment unit generates a laser beam with a main band for measuring the gas component and a laser beam with a subband from the laser beam. The lock unit locks the laser beam with the subband to the second resonator.

In the gas absorption spectroscopic instrument according to the first aspect, it is possible to stabilize the frequency of the laser beam and narrow the line width thereof without locking the laser beam to the resonator used for the CRDS measurement.

(Second Aspect) In the gas absorption spectroscopic instrument according to the first aspect, the frequency adjustment unit generates a laser beam with the main band and a laser beam with the subband by modulating the laser beam, the frequency adjustment unit includes a first generator that outputs a modulation signal for generating the laser beam with the main band, and a second generator that outputs a modulation signal for generating the laser beam with the subband, and the controller adjusts an oscillation frequency of the second generator so as to modify a frequency difference between the laser beam with the main band and the laser beam with the subband.

In the gas absorption spectroscopic instrument according to the second aspect, it is possible to freely sweep the main band after the line width of the laser beam with the main band is narrowed, and acquire a ringdown signal at a required frequency difference.

(Third Aspect) In the gas absorption spectroscopic instrument according to the first or second aspect, the first resonator is provided with an adjustment mechanism for adjusting a resonator length, the second resonator is not provided with the adjustment mechanism, and the controller adjusts a resonator length of the first resonator using the adjustment mechanism so as to cause the first resonator to resonate in the main band while locking the laser beam with the subband to the second resonator.

In the gas absorption spectroscopic instrument according to the third aspect, t the frequency of the laser beam with the main band is also stabilized and the line width thereof is also narrowed in the first resonator.

(Fourth Aspect) The gas absorption spectroscopic instrument according to any one of the first to third aspects further includes a second frequency stabilization circuit, wherein the second frequency stabilization circuit locks the laser beam with the main band to the first resonator.

In the gas absorption spectroscopic instrument according to the fourth aspect, the ringdown signal can be constantly acquired without considering the deviation of the resonance frequency between the first resonator and the laser beam.

(Fifth Aspect) The gas absorption spectroscopic instrument according to the fourth aspect further includes an acousto-optic modulator disposed between the light source and the first resonator, wherein the second frequency stabilization circuit controls a frequency of the acousto-optical modulator.

In the gas absorption spectroscopic instrument according to the fifth aspect, the frequency of the acousto-optic modulator is controlled by the second frequency stabilization circuit.

(Sixth Aspect) In the gas absorption spectroscopic instrument according to the fourth or fifth aspect, the second frequency stabilization circuit controls a resonator length of the first resonator.

In the gas absorption spectroscopic instrument according to the sixth aspect, the resonator length of the first resonator is controlled by the second frequency stabilization circuit.

(Seventh Aspect) The gas absorption spectroscopic instrument according to the second aspect further includes a second frequency stabilization circuit, wherein the second frequency stabilization circuit locks the laser beam with the main band to the first resonator, and the second frequency stabilization circuit controls a frequency of the second generator.

In the gas absorption spectroscopic instrument according to the seventh aspect, the frequency of the second generator is controlled by the second frequency stabilization circuit.

Although the embodiments of the present invention have been described, it should be understood that the embodiments disclosed herein are illustrative and non-restrictive in all respects. The scope of the present invention is defined by the scope of the claims and encompasses all modifications equivalent in meaning and scope to the claims.

WHAT IS CLAIMED IS:

1. A gas absorption spectroscopic instrument that measures a gas component, the gas absorption spectroscopic instrument comprising:
a light source that outputs a laser beam for measuring the gas component;
a first resonator into which the laser beam is input;
a photodetector that detects a laser beam output from the first resonator;
a controller that measures the gas component based on an output signal from the photodetector; and
a first frequency stabilization circuit disposed between the light source and the first resonator to form a negative feedback circuit, wherein
the first frequency stabilization circuit includes:
a second resonator having a finesse lower than that of the first resonator;
a frequency adjustment unit that adjusts a frequency of the laser beam; and
a lock unit that locks the laser beam to the second resonator,
the frequency adjustment unit generates a laser beam with a main band for measuring the gas component and a laser beam with a subband from the laser beam, and
the lock unit locks the laser beam with the subband to the second resonator.

2. The gas absorption spectroscopic instrument according to claim 1, wherein
the frequency adjustment unit generates a laser beam with the main band and a laser beam with the subband by modulating the laser beam,
the frequency adjustment unit includes a first generator that outputs a modulation signal for generating the laser beam with the main band, and a second generator that outputs a modulation signal for generating the laser beam with the subband, and
the controller adjusts an oscillation frequency of the second generator so as to modify a frequency difference between the laser beam with the main band and the laser beam with the subband.

3. The gas absorption spectroscopic instrument according to claim 1, wherein
the first resonator is provided with an adjustment mechanism for adjusting a resonator length,
the second resonator is not provided with the adjustment mechanism, and
the controller adjusts a resonator length of the first resonator using the adjustment mechanism so as to cause the first resonator to resonate in the main band while locking the laser beam with the subband to the second resonator.

4. The gas absorption spectroscopic instrument according to claim 1, further comprising:
a second frequency stabilization circuit,
wherein the second frequency stabilization circuit locks the laser beam with the main band to the first resonator.

5. The gas absorption spectroscopic instrument according to claim 4, further comprising:
an acousto-optical modulator disposed between the light source and the first resonator,
wherein the second frequency stabilization circuit controls a frequency of the acousto-optical modulator.

6. The gas absorption spectroscopic instrument according to claim 4, wherein
the second frequency stabilization circuit controls a resonator length of the first resonator.

7. The gas absorption spectroscopic instrument according to claim 2, further comprising:
a second frequency stabilization circuit,
wherein the second frequency stabilization circuit locks the laser beam with the main band to the first resonator, and
the second frequency stabilization circuit controls a frequency of the second generator.
